(19) United States
(12) Patent Application Publication
(10) Pub. No.: US 2006/0134960 A1
(43) Pub. Date: Jun. 22, 2006

(54) Card edge connector

(75) Inventors: XianqQi Yang, Kunsan (CN); Ren-Chih Li, Tu-Chen (TW); XhiXi Zhang, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/168,609

(22) Filed: Jun. 27, 2005

(30) Foreign Application Priority Data
Dec. 17, 2004 (CN) 200410065812.0

(51) Int. Cl. H01R 13/62

(52) U.S. Cl. 439/328

(57) ABSTRACT

This invention is related to a card edge connector (1). The card edge connector has an insulative housing (2) defining a plurality of slots (56) for receiving a corresponding number of terminals (3) therein. A pair of support devices (40) are firstly secured in the insulative housing. A pair of reinforcement devices (40) are secondly and detachable secured to the insulative housing and cooperated with the corresponding support devices respectively. The reinforcement device can be detached to reuse in another insulative housing.

### BACKGROUND OF THE INVENTION

1. Field of the Invention

The present invention relates to a card edge connector, more particularly to a card edge connector that having a reinforcement member including a reinforcement device and a support device in cooperation with each other.

2. Description of Related Art

A card edge connector, such as U.S. Pat. No. 6,817,875, wherein the card edge connector has a housing defining an elongated slot along a longitudinal direction thereof. A plurality of passageways are defined by two sides of the slot in the housing. A plurality of contacts are received within the corresponding passageways with contact portions extending into the slot. A pair of supporting platforms are formed at two opposite ends of the housing. A pair of latch devices are disposed on the corresponding supporting platforms, respectively. Each latch device includes a plastic member and a metal member commonly deflectable with regard to the housing. A substrate module is inserted into the slot. The module defines a pair of notches in two side portions and a pair of grounding pads respectively on both surfaces thereof around each of said notches. The plastic member defines a locking protrusion and a restriction protrusion respectively abutting against the upper surface and received within the notch of the module, while the metal member defines a pair of grounding tangs respectively engaged with the corresponding grounding pads on two opposite surfaces of the module.

The card edge connector described as U.S. Pat. No. 6,817,875 has an excellent locking function with the module. However, in practice, the housing of the card edge connector has a different height to save the space of the circuit board. When the height of the housing has changed, the metal member of the latch device must be changed, this usually lead to a high cost for changing the metal member. Furthermore, the metal member is made of a metal piece, and has a number of bending portions, this not only complex the process of making, but also enhance the cost of producing.

Hence, an improved card edge connector is desired to overcome the disadvantages and problems of the prior art.

### SUMMARY OF THE INVENTION

Accordingly, it is an object of the present invention to provide a card edge connector having a detachable reinforcement member facilitated to use in different height of the card edge connector.

Another object of the present invention is to provide a card edge connector having a detachable reinforcement member with a simple processing of making.

In order to achieve the above mentioned objects, A card edge connector adapted to establish electrical connection between a circuit board and a card, comprises an insulative housing having a plurality of terminals therein and a pair of reinforcement member detachably secured in two ends of the insulative housing. The insulative housing has an elongated body provided with an insert groove along a length direction along the insulative housing for insertion of one end of the card thereinto. The elongated body defines a plurality of slots therein. The two ends of the elongated body along the longer side thereof have respective support arms projecting forwardly and integrally therefrom. The terminals respectively disposed in the slots have contact ends received into the insert groove to electrically contact with the card, and coupling ends to be electrically connected to the circuit board. Each of the detachable reinforcement memmber comprises a support device and a reinforcement device respectively mounted on to said support arms and cooperated with each other. The support device comprises a mounting section to mount to the circuit board, and an adjusting section that can be adjusted to meet the requirement of different height of the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective and front view of the assembled card edge connector in accordance with the present invention;

FIG. 2 is a perspective view of the assembled card edge connector taken from another aspect according to the present invention;

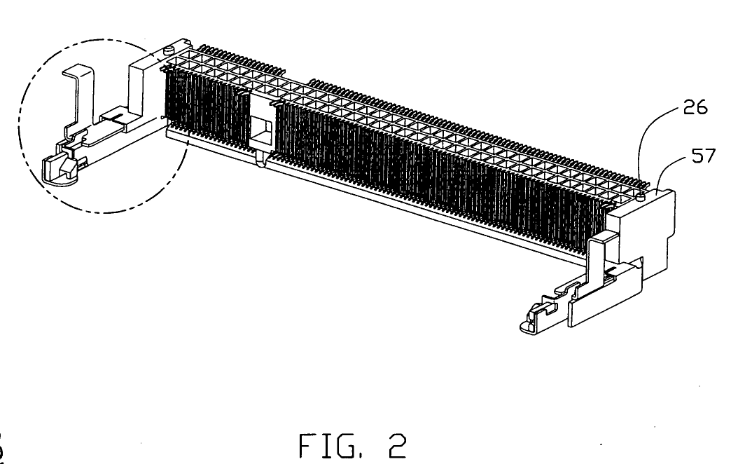

FIG. 3 is a exploded, perspective view of the card edge connector according to the present invention;

FIG. 4 is a exploded, perspective view of the card edge connector taken from another aspect according to the present invention;

FIG. 5 is a partial perspective view of the card edge connector of FIG. 1 to show an engagement of a reinforcement member and a insulative housing; and

FIG. 6 is a partial perspective view of the card edge connector of FIG. 2 to show an engagement between the reinforcement member and the insulative housing taken from the another aspect.

### DETAILED DESCRIPTION OF THE INVENTION

Reference will now be made to the drawing figures to describe the present invention in detail.

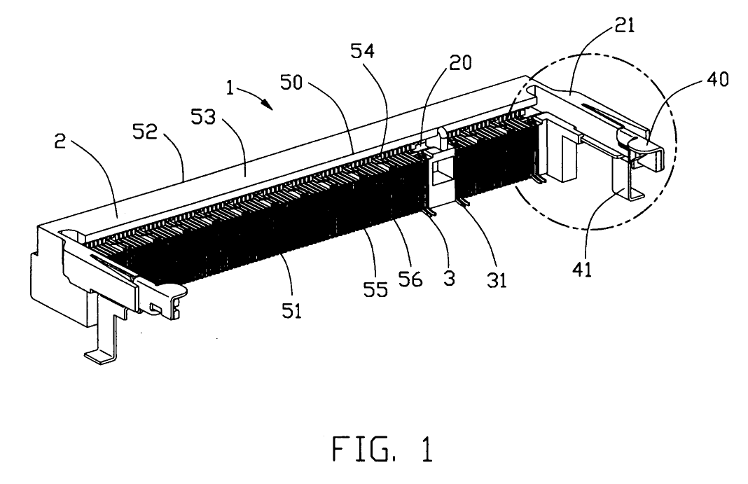

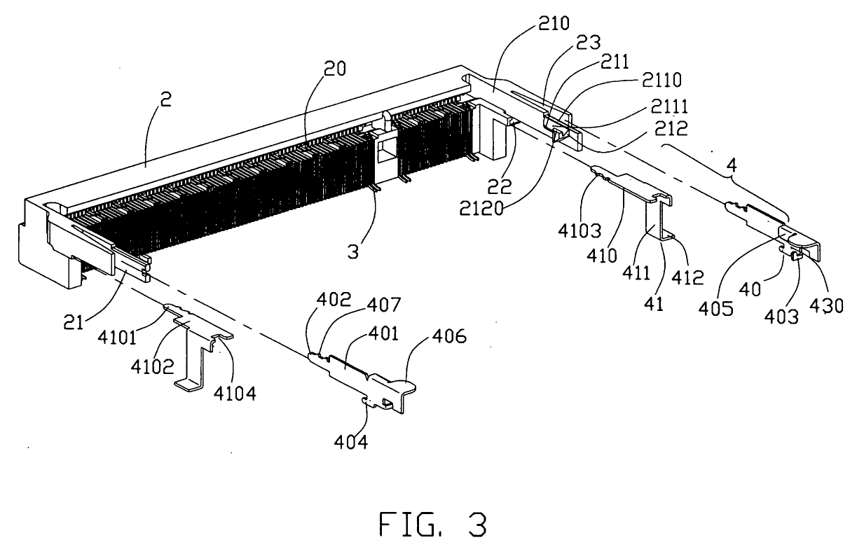

With reference to FIGS. 1 and 3, a card edge connector 1 of the present invention is adapted to be mounted to a circuit board (not shown) for insertion of an electronic card (not shown) so as to enable the circuit board to electrically connect with the electronic card by means of the card connector 1. The card connector 1 mainly includes an insulative housing 2 having a plurality of terminals 3 therein, and a pair of reinforcement member 4 respectively disposed and detachably secured on two opposite ends of the insulative housing 2.

Reference is made to FIG. 1, the insulative housing 2 has an elongated rectangular body 50. The rectangular body 50 has a first face 51 in the front, a second face 52 at the rear, and a top face 53. The first face 51 is formed with an insert groove 20 along a longer side thereof for insertion of a connecting end of the electronic card. The insert groove 20 of the rectangular body has an upper side wall 54 and a lower side wall 55 which are provided with a plurality of slots 56 that extend from the first face 51 to the second face 52. Each slot 56 receives a respective one of the conductive terminals 3 therein. The conductive terminals 3 have contact ends (not labeled) disposed in the insert groove 20 to electrically contact with a plurality of terminals of a connecting end of the electronic card. The coupling ends (not labeled) of the conductive terminals 3 extend outwardly of insulative housing 2 to thereby electrically connect with the circuit board. The electrical connection between the coupling ends of the conductive terminals 3 and the circuit board can be established in any conventional manner, such as surface mounting technique, passing the coupling ends through through-holes in the circuit board for subsequent furnace reflow and soldering, etc.

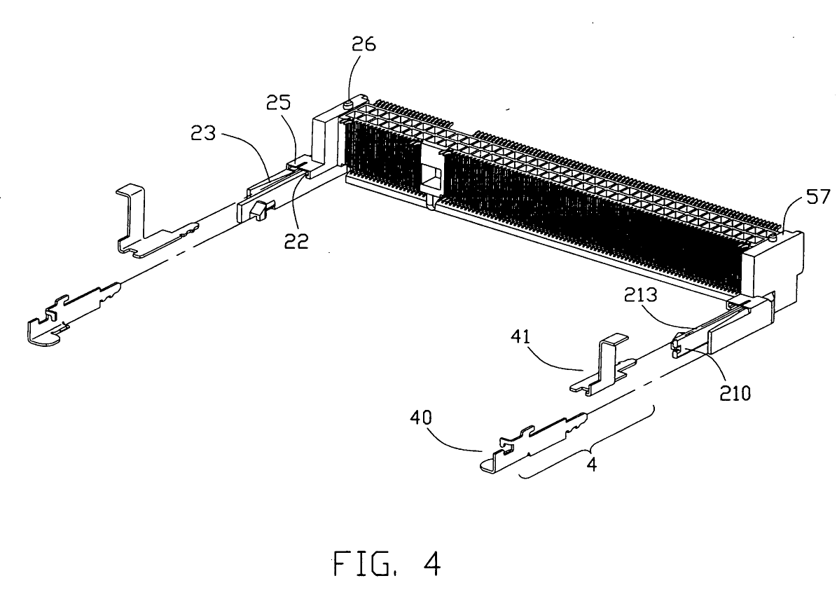

Referring to FIG. 4, two ends of the insulative housing 2 along the longer side thereof have respective support arms 21 projecting forwardly and integrally therefrom and parallel to the circuit board. The insulative housing 2 has a bottom face 57 having a pair of symmetrical post 26 projecting from the two ends thereof for positioning the card edge connector 1 to the circuit board. Each support arm 21 has a horizontal platform 25 defining a horizontal groove 22, and a vertical portion 210 defining a vertical groove 23 therein. The vertical portion 210 is divided into an inner vertical portion 213 and an outer vertical portion (not labeled) by the vertical groove 23. A lower edge portion 2110 (shown in FIG. 3) is formed at a free end of the inner vertical portion 213. A latch recess 211 is formed at one inner side of the lower edge portion 2110 and toward the other support arm 21. Referring to FIG. 3, a lug 212 is projected from the front section of the latch recess 211, and is designed to received in a respective one of recesses in the left and right sides of the electronic card so as to generate interference with the electronic card.

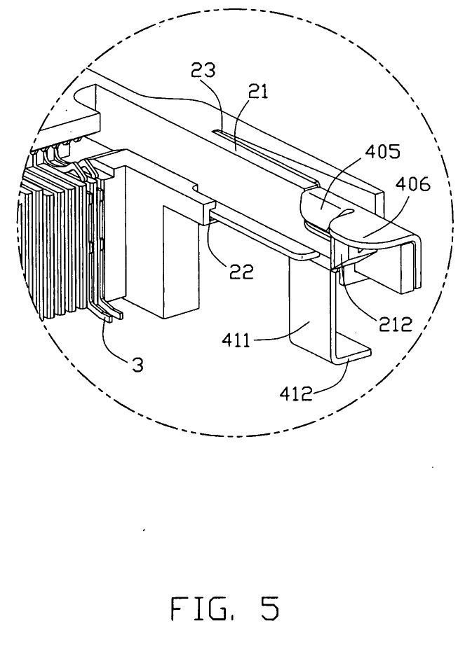

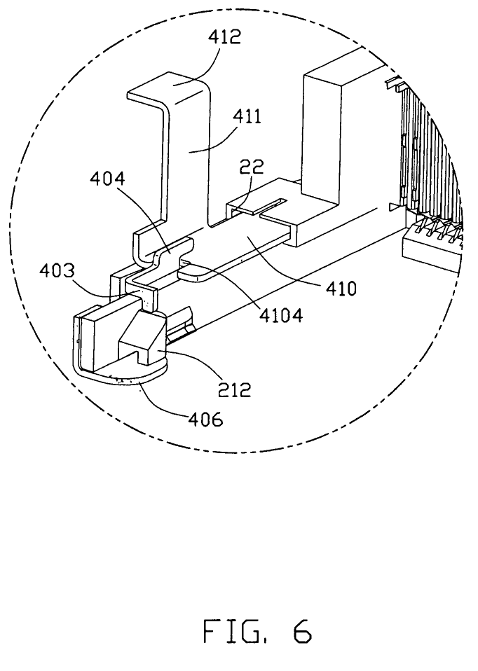

Referring to FIGS. 3-6, the reinforcement member 4 includes a reinforcement device 40 and a support device 41 separated from and cooperated with each other. The support device 40 is made by a metal sheet, and also as the reinforcement device 41. Wherein, the support device 41 is firstly inserted into the horizontal groove 22, and the reinforcement device 40 is secondly detachably inserted into the vertical groove 23 and engaged with the support device 41.

The support device 41 made by a metal piece, in a general Z-shape or a general [symbol] -shape, includes a supporting section 410, an adjusting section 411 extending perpendicularly from one outer side of the supporting section 410, and a mounting section 412 connected with the adjusting section and parallel to the supporting section to parallelly mount the circuit board. The supporting section 410 in a planar-shape has a planar face (not labeled) abutting against a bottom face (not labeled) of the support arm 21 to protect the support arm 21 from damaging when a force is applied onto the support arm from up to down. The adjusting section 411 has an adjustable length adjusted to meet the different height of the insulative housing 2. A metal piece 4101 is narrower than the supporting section 410 and extends from an end of the supporting section 41. The metal piece 4101 with a plurality of barbs 4103 is used to interferentially insert into the horizontal groove 22 to secure the support device 41 to the support arm 21.

The reinforcement device 40 has a main body 401 surrounding one outer sidewall of the inner vertical portion 213. A metal piece 402 similar to the metal piece 4101 extends from an end of the main body 401 of the reinforcement device 40, and has a plurality of barbs 407 for interferential insertion into the vertical groove 23 of the respective support arm 21. The main body 401 has a locking piece 406 extending perpendicularly from one upper edge thereof remote from the rectangular body 50 and toward the other support arm 21. The lug 212 of the support arm 21 has a top face 2120 covered by the locking piece 406. An engaging tag 405 adjacent to the locking piece 406 extends from the main body 401, and is positioned in the locking recess 211 of the support arm 21. A locking section 404 and a restricting tag 403 extends form a lower edge 430 of the main body 401. The restricting tag 403 and the engaging tag 405 are for further securing the reinforcement device 40 to the support arm and restricting the reinforcement device 40 to move remotely relative to the support arm 21. The locking section 404 is used to detachably form an intersection with an opening recess 4104 defined in a free end of the support device 41 to restrict the support device move to the support arm in a rear or right or left direction.

In practice, the space of the circuit board is limited, the insulative housing 2 must be made in a different height to save the space of the circuit board. Correspondingly, the reinforcement member 4 must to be changed to meet the changing height of the insulative housing 2. The reinforcement member 4 according to the present invention includes the support device 41 and the reinforcement device 40 which are detachably engaged with each other, wherein the reinforcement device 41 can be detached to mount to any one insulative housing with different height. As a result, to meet the changing of height of the insulative housing 2, one operator only need to change the support device 41 and retain the reinforcement device to reuse still. Thereby, the reinforcement member 4 is facilitated to use in different height of the card edge connector, and decrease greatly the cost of changing the reinforcement member which is made by only one metal piece. Furthermore, this detachable structure of the reinforcement device 40 and the support device 41 of the present invention greatly decreases a number of the bending portions compared with the aforementioned prior art which is made by only one metal sheet, and thereby realizes to simple process of making and decrease cost of producing.

Although the present invention has been described with reference to the preferred embodiment, it is apparent to those skilled in the art that a variety of modifications and changes may be made without departing from the scope of present invention which is intended to be defined by the appended claims. Such as if the support arm is not parallel to the circuit board when the card edge connector is mounted to the circuit board, the reinforcement member according to the present invention still has the excellence that facilitating to use in the insulative housing having different height. At this time, the operator only need to change an angle between the support section and the adjusting section, or an angle between the adjusting section and the mounting section, to ensure the mounting section parallelly soldering to the circuit board. Furthermore, the position relationship between the support device and the reinforcement device can be changed according to a practical requirement, such as the support device can received in the insulative housing adjacent to the support arm or in a bottom face of the support arm to secure the support device on the insulative housing, wherein support section of the support device may not be perpendicular to the reinforcement device.

We claim:

1. A card edge connector adapted to establish an electrical connection between a circuit board and a card, comprising:
an insulative housing having an elongated body, said body provided with an insert groove extending in a lengthwise direction along said insulative housing for insertion of one end of the card thereinto, and defining a plurality of slots therein, two opposite ends of said body along a longer side thereof projecting respective support arms in a same direction, each said support arm has a lug projected therefrom to generate interference with the card;
a plurality of terminals respectively disposed in said slots and having contact ends received in said insert groove to electrically contact with the card, and coupling ends to be electrically connected to the circuit board;
a pair of support device stamped by a metal piece firstly secured to the insulative housing, and each support device comprising an main body having an end embedded into the insulative housing, an adjusting section extending from the main body to the circuit board, and a mounting section extending from the adjusting section to mount to the circuit board; and
a pair of reinforcement device secondly secured onto said support arms respectively, each reinforcement device detachably secured to each support arm for facilitating to reuse to another card edge connectors with a changed height, and comprising a main body having a reinforcement piece extending therefrom to engage with an free end of the support device.

2. The card edge connector in accordance with claim 1, wherein the main body of the support device is horizontally secured to the support arm, and wherein the main body of the reinforcement device is vertically secured to the support arm.

3. The card edge connector in accordance with claim 1, wherein the free end of the support device has a recess to form an intersection with the reinforcement piece of the reinforcement device to restrict the support device moving to the support arm.

4. The card edge connector in accordance with claim 1, wherein the end of the support device embedded in the insulative housing is an inserting piece with at least one barbs to interferential insert into the insulative housing.

5. The card edge connector in accordance with claim 1, wherein support arm comprise a horizontal platform received the support device and a vertical portion extending perpendicularly from the platform received an end of the reinforcement device.

6. The card edge connector in accordance with claim 5, wherein the main body of the support device is in a planar shape and abutting against a bottom face of the vertical portion to support the support arm.

7. The card edge connector in accordance with claim 5, wherein the vertical portion has a vertical groove to receive the partial main body of the reinforcement device, and is divided into an inner vertical portion and outer vertical portion by the vertical groove, and wherein the main body of the reinforcement device is in a planar shape and abutting against a sidewall of the inner vertical portion.

8. The card edge connector in accordance with claim 1, wherein the insulative housing has a pair of symmetrical post projecting from a bottom face of the insulative housing for positioning the card edge connector to the circuit board.

9. The card edge connector in accordance with claim 1, wherein the support device is received in two opposite ends of the insulative and adjacent to the support arm.

10. The card edge connector in accordance with claim 1, wherein the reinforcement device has two engage tags extending from two opposite edges thereof to further secure the reinforcement device to the support arm.

11. The card edge connector in accordance with claim 1, wherein the mounting section and the main body of the support device are parallel to the circuit board.

12. The card edge connector in accordance with claim 1, wherein the reinforcement device has a reinforcement piece extending perpendicularly from one end thereof remote from the elongate body and toward the other opposite support arm, and wherein the lug is covered by the reinforcement piece.

13. The card edge connector in accordance with claim 1, wherein the reinforcement device is stamped and formed by at least one metal piece.

14. A card edge connector comprising:
an insulative housing defining an elongated main body with an elongated central slot therein for receiving a daughter board, said central slot high rising from a bottom face of the housing;
a plurality of contacts disposed in the housing with contact portions extending into the central slot;
a pair of deflectable plastic latches integrally extending forwardly from two opposite ends of the main body, each of said latches including means for locking the daughter board in the connector and each of said latches essentially located at a same level with the central slot while being vertically spaced from the bottom face of the housing; and
a pair of metallic reinforcement members attached to the housing, each including a reinforcement device and a support device being discrete from each other; wherein
the reinforcement device grasps is movable with the corresponding plastic latch for reinforcing the plastic latch, while the support device includes means for securing to a printed circuit board on which the connector is mounted and is thus immoveable.

15. The connector as claimed in claim 14, wherein said reinforcement member further includes coupling device on the reinforcement device and the support device for restricting lateral deflection of the reinforcement device and the corresponding plastic latch which is grasped by the reinforcement device.

16. The connector as claimed in claim 14, wherein said reinforcement device has a vertical dimension similar to the plastic latch while the support device defines a variable height according to how high the central slot is.

17. A method of arranging different type card edge connectors, comprising steps of:
providing an insulative housing with a main body defining a high rising central slot wherein a pair of plastic latches integrally extending forwardly from two opposite ends of the main body and essentially located at a same level with the central slot;
disposing a plurality of contacts in the housing in communication with the central slot;
attaching a pair of reinforcement members to the housing, wherein said reinforcement member includes a reinforcement device and a support device, under a condition that the reinforcement device grasps and is moveable with the corresponding plastic latch while said support device is immoveably fixed to a printed circuit board on which the connector is mounted.

18. The method as claimed in claim 17, wherein the reinforcement device is essentially defined with a standard size while a vertical dimension of the support device is variable according to a height of the central slot.
